(19) United States
(12) Patent Application Publication
(10) Pub. No.: US 2005/0156027 A1
(43) Pub. Date: Jul. 21, 2005

(54) Method and apparatus for vending magic, pranks, and gags

(76) Inventor: Geno Munari, Las Vegas, NV (US)

Correspondence Address: LEWIS AND ROCA LLP, 40 NORTH CENTRAL AVENUE, PHOENIX, AZ, 85004, US

(21) Appl. No.: 10/997,567

(22) Filed: Nov. 24, 2004

Related U.S. Application Data
(60) Provisional application No. 60/525,043, filed on Nov. 25, 2003.

(51) Int. Cl. G06F 7/08

(52) U.S. Cl. 235/381

(57) ABSTRACT

A method and apparatus for vending magic, pranks, and gags through a vending machine is described. Through use of a video display, a vending machine may demonstrate performance of a magic trick, prank, or gag, enticing customers to purchase items from the machine. A user interface is provided for selecting the item by its advertised indicia, and a method is provided to allow ordering catalogs or items through mail-order delivery. Further, a method is provided to demonstrate confidential performance information through video displays or secure web interfaces, in a manner that educates the purchaser but protects the secrecy of the magic trick.

### CROSS REFERENCES TO RELATED APPLICATIONS

This application claims the full benefit and priority of U.S. Provisional Application Ser. No. 60/525,043, filed on Nov. 25, 2003, the disclosure of which is fully incorporated herein for all purposes.

### STATEMENT REGARDING FEDERALLY SPONSORED RESEARCH OR DEVELOPMENT

Not applicable.

### BACKGROUND OF THE INVENTION

1. Field of the Invention

The present invention relates to a method and apparatus for vending products to the public, and in particular, to a method for vending magic, pranks, and gags from a vending machine.

2. Description of the Related Art

For many years, people young and old have been captivated by the performance of magic and illusions. While many entertainers and illusionists have achieved fame before live audiences and television, there are members of the public who, inspired by these great performers, desire to perform magic acts themselves.

Commercially available magic tricks allow members of the public to individually learn the secrets behind the performance of magic tricks and illusions, enabling them to astound and impress audiences who do not know how the feats are performed. These commercial magic tricks are available for purchase by mail order and at businesses that deal in magic tricks and other related materials such as pranks or gags. However, it is not always convenient or practical to travel to a specialty store to obtain a commercially-available magic trick, especially when certain sectors of the public, such as children, have difficulty obtaining ready transportation.

Vending machines offer a means to sell products to the public without the need to have a dedicated storefront. By selling products in a stand-alone machine, products may be offered twenty-four hours a day, and in locations that would be too costly or difficult to establish a traditional business. As an added advantage, vending machines do not require a dedicated attendant to oversee transactions with the public, and can be installed in areas frequented by the demographic of the population that may be most interested in a particular product. Yet, many items, such as magic, pranks, and gags, have not been offered for sale in a vending machine environment. One reason for this limitation is that it is not always readily apparent how the performance of a magic trick will appear to an audience just by a picture and a description on a package. The magic is in the performance, not the trick itself.

By viewing a video performance of a magic trick, the potential customer can see how a member of the audience can be impressed by its performance, bringing to life the illusion that the magic trick offers. The visual demonstration of the magic trick becomes a powerful marketing tool to educate the potential consumer as to its entertainment value, and also allows the consumer to select a magic trick that is appropriate for the consumer's skill level. It is also well understood that a dynamic, moving advertising message catches the attention of consumers far more effectively than a fixed picture.

In addition to a promotional role, video displays can also be used as an effective teaching tool, and can assist consumers in learning how to perform a magic trick. The Magician's Code, however, requires that the “secret” behind a magic trick not be revealed to someone who is uninterested in protecting its confidentiality. If a magic trick's secret becomes well known, the public loses interest in the wonder of the performance and instead focuses on the mechanics of the operation of the trick. However, some magic tricks are complicated enough in their operation that the performer could greatly benefit by a video presentation showing how to manipulate the magic trick to achieve the intended audience performance.

Therefore, what is needed is an apparatus to vend magic, pranks, and gags to the public through a venue other than a traditional business establishment. What is also needed is a means to demonstrate performance of an item that is offered for sale, educating the consumer about how the trick looks when performed and enticing the consumer to purchase the magic item. What is also needed is a means to display a video performance to a consumer that educates the consumer about how to perform a purchased magic trick without divulging the confidential information to the general public. What is also needed is a means to monitor a vending machine remotely, and to download images and video graphics to the machines' monitor. What is also needed is an improved customer interface beyond simple keypad control.

Additional objects and advantages of the invention will be set forth in part in the description that follows, and in part will be obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed. Thus, the present invention comprises a combination of features, steps, and advantages that enable it to overcome various deficiencies of the prior art. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of a preferred embodiment of the present invention, reference will now be made to the accompanying drawings, which form a part of the specification, and wherein:

FIG. 1 depicts a vending machine for selling magic, pranks, and gags in accordance with the present invention;

FIG. 2 depicts another embodiment of a vending machine for selling magic, pranks, and gags;

FIG. 3 illustrates a block diagram for one embodiment of the present invention;

FIG. 4 depicts another embodiment of a vending machine for selling magic, pranks, and gags;

FIG. 5A illustrates a flow diagram for one method of the present invention whereby a display state machine is defined; and,

FIG. 5B continues the flow diagram of FIG. 5A.

### DETAILED DESCRIPTION OF THE PREFERRED EMBODIMENT

Reference will now be made in detail to exemplary embodiments of the invention, examples of which are illustrated in the accompanying drawings. Wherever possible, the same reference numbers will be used throughout the drawings to refer to the same or like parts.

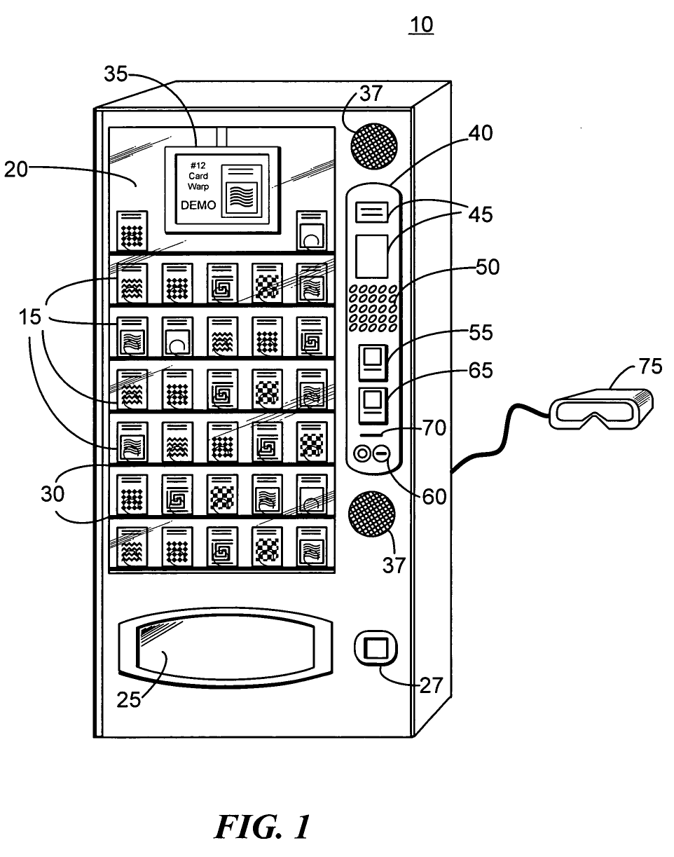

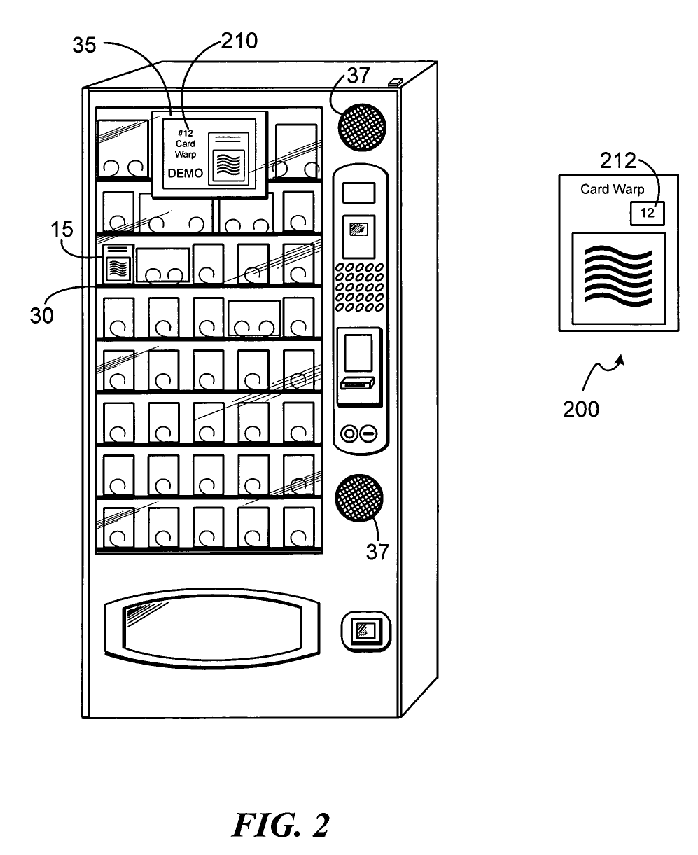

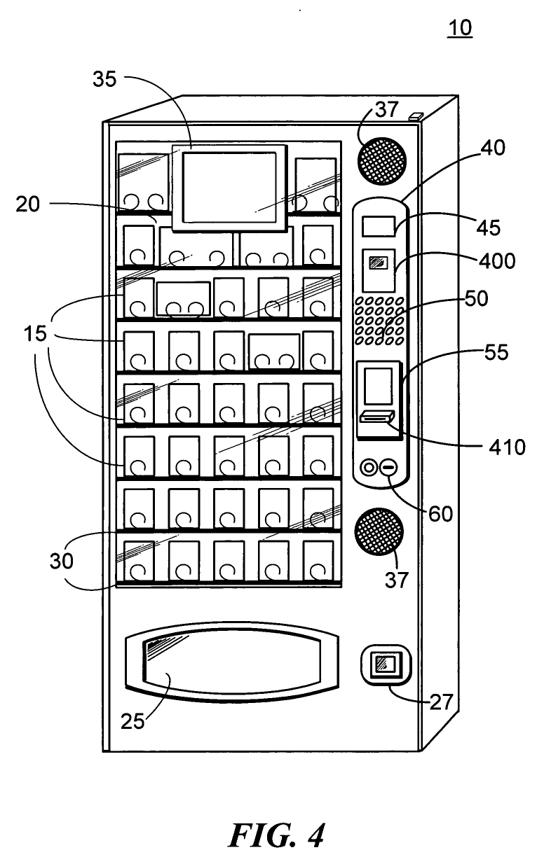

FIG. 1 illustrates one embodiment of a vending machine in accordance with the present invention, and a similar alternate embodiment is shown in FIG. 4 with reference numbers identifying same or like parts. The vending machine (10) is comprised of a storage area for the products to be vended (15), which is visible behind and is enclosed by a transparent panel (20) such as tempered glass or transparent resin. Products (15) are dispensed by a traditional auger and tray system as is commonly used in food-vending machines. Upon purchase, the selected product is dispensed by the machine through a rotation of the auger where the product was temporarily stored, and after disengaging the auger coil, the purchased product drops to a product delivery cavity (25) where the consumer may remove the purchased product from the machine. If change is due, such change may be dispensed in the coin return cavity (27), and in one embodiment, is capable only of dispensing one dollar coins as change. With each product (15) is also associated a product indicia, such as an item number, that enables a purchaser to uniquely identify a particular product in the machine for purchase, such product indicia being displayed either on the product or proximate to the product in the machine, such as in the shelf (30) below the product. Product indicia are further discussed below in relation to FIG. 2.

The machine (10) further comprises a video display (35) that may provide visual content such as: pictures of products (15) in the machine (10); video presentations of performance of products (15) available for purchase; pricing, and/or advertising information about products (15); purchase information including product indicia of items in the machine (15), or directions to the customer for completing a transaction. Those of skill in the art recognize that the display (35) may be implemented through a number of means such as a cathode ray tube, liquid crystal display, plasma display, thin-film transistor display, or any other type of video display. Further, those of skill in the art also may realize that placement of the display (35) may be in a position other than those shown in FIG. 1 and FIG. 4, and that the display may be of a different size or aspect ratio than the display (35) illustrated in FIG. 1 or FIG. 4.

The machine (10) further comprises an optional audio output device such as one or more speakers (37) that may annunciate audio information synchronized to the display to further promote performance of the magic trick, or to capture the attention of passers-by. Those of skill in the art may appreciate that one or more speakers (37) may be placed entirely within the interior space of the machine (10), making external speaker grilles as shown in FIG. 1 and FIG. 4 unnecessary.

The embodiments of the machine in FIG. 1 and FIG. 4 further comprise a selector panel (40) that in one embodiment is the primary means for customer input and tender of payment. The selector panel (40) is further comprised of an optional number of informational displays (45) that may present instructions or transaction information such as price, amount tendered, or prompts for the customer to select an alternate item or insert additional funds. A keypad (50) is provided for customer entry of indicia that initiate the delivery of a purchased product, such as an item number corresponding to a particular product's indicia. In an alternate embodiment, customer input is provided in whole or part through a microphone within the vending machine (10) that receives audio input from the customer, allowing a computer-based processor in the machine (10) to perform speech recognition from the received voice input, and act upon voice commands from the customer. In yet another embodiment, the keypad area (50) is implemented through a keyboard such as those utilized with desktop or laptop computers. In yet another embodiment, the transparent panel (20) has transparent touch-sensitive areas located in front of each product (15), and customers may select an item by touching the area on the transparent panel (20) in front of an item (15). In still another embodiment, display (35) is implemented through a touch panel display located in an area of the machine (10) that is convenient for customers to touch directly, and customers interact with the machine (10) through touching prompted areas of the screen of display (35). Those of skill in the art also recognize that products (15) dispensed by the machine (10) may comprise printed product catalogs that further enable customers to obtain products offered for sale but not necessarily available in machine (10).

The selector panel (40) in FIG. 1 and FIG. 4 is further comprised of an optional cash acceptor (FIG. 1, 55) (FIG. 4, 410) that accepts paper currency to complete the transaction, as well as a coin slot (60). The selector panel (40) may also have an optional card reader/writer (FIG. 1, 65) that accepts cards such as credit, debit, or gift cards. The card reader/writer (65) may read data from a card entered by a customer, initiate a transaction through a central processor to validate the transaction, and optionally write data back to the card that the customer placed in card reader/writer (65). The card reader/writer (65) may also accept and allow processing for club cards or frequent purchaser cards. Through providing a write-back capability to card reader/writer (65), a gift card that comprises a pre-set data value corresponding to a gift amount stored within the card's storage medium may be read from the card's storage device, a product (15) purchased from the machine (10), and the appropriate amount subtracted from and written back to the storage medium stored in the gift card. Those of skill in the art recognize that such storage media may include magnetic stripes or regions, smart chips, or other storage mechanisms. By displaying the existing value on the card after it is initially read, the customer may select items that are purchasable by the remaining dollar-equivalent balance on the card.

Also shown on selector panel (40) is a print out slot (FIG. 1, 70), that in one embodiment of the invention dispenses a receipt for the purchase. Alternatively, the slot (70) could dispense information such as printed instructions on performing the purchased trick, or an authorization code/password and internet address (URL) to access an internet site that contains written and/or video demonstrations of performance secrets. Alternatively, the internet address and access code or password to see the “how to perform” internet video presentation may be contained within the package of the product (15) that the consumer purchases. Therefore, each purchased product not only comprises the magic trick and written instructions, but also access information that allows restricted use of a website that is dedicated to teaching the customer how to perform the trick. While the customer is visiting the video tutorial website, advertising information could also be presented to promote additional products for sale. Since the nature of the access to the website is sensitive and comprises confidential information, after the site has been accessed a limited number of times by a specific password, the website may optionally disable access for that password, routing the query to a general product catalog for future purchases.

To demonstrate the confidential performer's view of a magic trick purchased by a customer, the vending machine (10) may also prompt the customer to look into an attached privately-viewable secure viewing device (FIG. 1, 75) or a window (FIG. 4, 400) and watch a presentation that demonstrates how to perform the purchased magic trick. Since the secrets behind the purchased magic trick are revealed in this device, the binocular form factor (75) and the narrow window aperture (400) is purposely intended to allow only one person to view the confidential performance information. Likewise, the confidential performance information is limited to a fixed time period or a limited number of viewings to prevent passersby from picking up and gazing in the viewing device without having purchased a magic trick. Those of skill in the art also may realize that alternative means exist to demonstrate confidential video performance information, comprising such means as attaching the viewing device (75) to a rotatable and adjustable mount on the machine (10), providing view-limited video screens through polarized displays, hooded monitors or screens, or having an aperture in the cabinet of the machine (400) that enables the customer to peer into a screened display device and view the confidential performance video. Those of skill in the art recognize that the window (400) may be placed higher or lower depending on the target demographic (e.g. children) or the window could further comprise an elongate glass segment disposed vertically along the vertical axis of the machine (10) that has a slidably engaged plastic aperture to allow customers to adjust the aperture to their particular viewing height.

Turning now to FIG. 2, an illustration of one embodiment of the present invention is presented. A product (15) is shown enlarged (200), and in one embodiment, illustrates a product indicia (210, 212). As discussed above, such indicia (212) could also be located in the machine (10) proximate to the product (15). The video display (35) demonstrates performance or promotional information of the product (15), and displays product indicia (210) corresponding to the product indicia shown on the package (212) or on the shelf (30) proximate to the corresponding product (15).

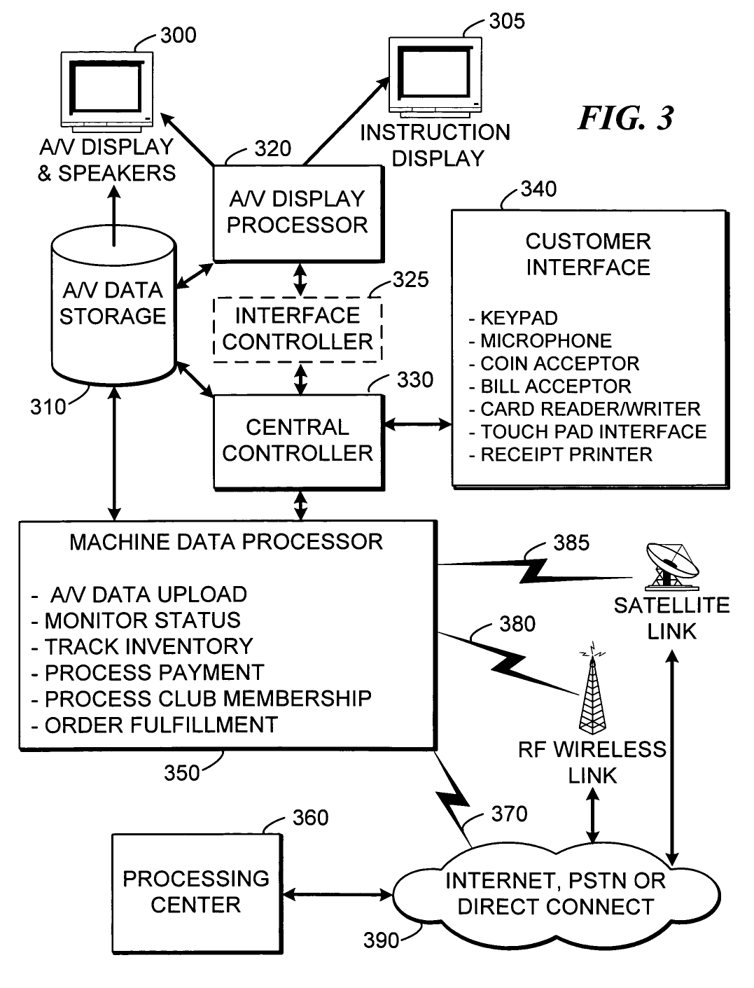

FIG. 3 illustrates a block diagram of one embodiment of the present invention. An A/V display and speakers (300) is connected to an audio/video data storage device (310) and an audio/video display processor (320). In one embodiment, the video display portion of the A/V display (300) is comprised of the video display (35) of FIGS. 1, 2, and 4; and the speakers are comprised of those shown (37) in FIGS. 1, 2 and 4. The storage device (310) and display processor (320) may be integrated into a single unit, comprising a device such as a digital videodisk player, laser disk player, video cassette recorder/player or part of a general purpose computer (such as an IBM PC-Compatible Embedded Computer with video output to displays (300, 305) and storage device (310) comprising a hard drive). Storage device (310) may be a hard disk storage medium, a RAM or FLASH memory storage device in either fixed or removable form, or any other storage medium capable of storing and recalling audio and video information. Such audio and video information may comprise, in one embodiment, digitally-encoded files in formats such as AVI or MPEG. A central controller (330) provides processing for transactions with customers, operates the machine, and provides an interface to a machine data processor (350). An optional interface controller (325) accepts commands from the central controller to instruct that processor (320) that a coin drop condition or a video demonstration request has occurred, and relays relevant data to the processor (320) so that it may either provide a promotional demonstration of the product on the publicly-visible display and speakers (300) or if a purchase has occurred, display the instructional tutorial only to the privately-viewable instruction display (305) within the machine (FIG. 1, 10) (FIG. 4, 10). In one embodiment, the instruction display (305) comprises an LCD panel display appropriate in size to fit within the machine (such as a 2-inch by 3-inch display) or an alternate type of display such as CRT or plasma. The instruction display (305) is visible only to users via a viewing device or such embodiments as described above in relation to FIG. 1 (75), or through a window aperture (FIG. 4, 400) in the machine (FIG. 4, 10). The controller (330) instructs the machine to dispense product when authorized by proper payment, provides a data interface from the machine data processor (350) to the audio/video data storage mechanism (310) and relays customer input from the customer interface (340) to the machine data processor (350) when appropriate. The controller (330) is further capable of printing product inventory/manifests for management of sales and product stocking. Those of skill in the art recognize that the machine data processor (350) may be integrated into the central controller (330) in an embedded computing device or general purpose computer.

The customer interface (340) of FIG. 3 provides the primary means of direct customer interaction with the present invention. The interface (340) comprises a keypad for accepting tactile customer input, an optional microphone for receiving customer voice input, a coin acceptor, informational displays, a paper currency bill acceptor, an optional card reader/writer, an optional touch pad interface, and an optional receipt printer. The interface (340) provides input to and receives output from the central controller (330), allowing the customer to tender payment, payment authorization to be performed, and the vending machine to dispense a particular item if payment was acceptable.

The machine data processor (350) provides an interface to an outside processing center (360) to enable upload, download, and processing of machine and transaction data. The machine data processor (350) communicates with the processing center (360) through a direct link (370), an RF Wireless link (380), or through a satellite link (385). The data transmission layer between the processor (350) and the processing center (360) may be implemented through a connection fabric such as (390) a direct hard-wired connection, the internet, through a connection to a public-switched telephone network (PSTN), or some combination of these techniques. Those of skill in the art also appreciate that the RF wireless link (380) and the connection fabric (390) could comprise a conventional cellular telephone link through TDMA, CDMA, AMPS, GPRS, PCS, GSM, or the like. The RF wireless link (380) could also comprise a WiFi interface through 802.11a, 802.11b, or 802.11g protocols, or through a short-range wireless standard such as Bluetooth. Those of skill in the art further appreciate that rather than periodic uploads of audio/video information to the data storage (310), the machine data processor may provide a direct uplink to an audio video source at the processing center (360), enabling audio/video information to be transmitted to the display (300) in real time. Further, the processing center (360) could be implemented within a mobile computer or handheld unit that connects to the machine (10) through its RF link.

The data processor (350), in addition to uploading audio/video data to the machine, monitors the status of the machine and may provide inventory tracking information to the central processor, such as in the event a particular item is sold out. The processor (350) may also alert the central processor if a built-in test function failed, or if the vending machine is being tampered with or damaged by weather. In addition, the payment processor (350) can process orders entered by the customer through the customer interface (340) so that products not available in the vending machine may be shipped directly to the customer's address. In one embodiment, if the machine is sold out of or does not stock an item, the customer will be presented with the option of having the product shipped to his or her address, such address being entered directly by the customer or through reading a customer-entered credit, debit, or club membership card.

In addition to transmitting and receiving credit/debit authorization information to and from the processing center (360), the machine data processor (350) can take appropriate actions for customers who enter either a club membership number through the customer interface (340) or who input a membership card into a card reader/writer in the interface (340). Such actions may comprise accruing purchase points toward the customer's membership account, offering discounts to the customer for product purchases, or other incentives for purchase such as frequent buyer programs. The data processor (350) also may subtract funds credited to a customer's gift card that is entered into the card reader/writer in the customer interface (340), and then direct the card reader/writer to adjust the remaining balance on the gift card's storage mechanism.

In another embodiment of the present invention, a customer is able to direct the machine (FIG. 1, 10) to display product information on the machine's display (FIG. 1, 35; FIG. 2, 300). Such product information may represent promotional information for products currently available for purchase in the machine (FIG. 1, 10), or for products sold out or not available for sale in the machine but available through special order or purchase at a store. Customer-viewable product information may be stored in the machine's A/V Data Storage device (FIG. 3, 310), uploaded on demand from the processing center (FIG. 3, 360) through the machine data processor (FIG. 3, 350), or provided from a link to a website that is routed by the machine data processor (FIG. 3, 350), output to the machine's display (FIG. 1, 35) and operated through customer input via devices such as the keypad (FIG. 1, 50), or through the machine's microphone and voice recognition processing. Through this embodiment, a customer can ask for a demonstration of any item offered for sale in the machine (FIG. 1, 10), or browse product information for any item offered for sale by the vendor. Customers may obtain a catalog directly from the machine or specify catalog delivery to an address, or in the alternative, order an item through the machine interface that is to be delivered to a customer-specified address, further comprising options to include gift packaging and/or a gift message.

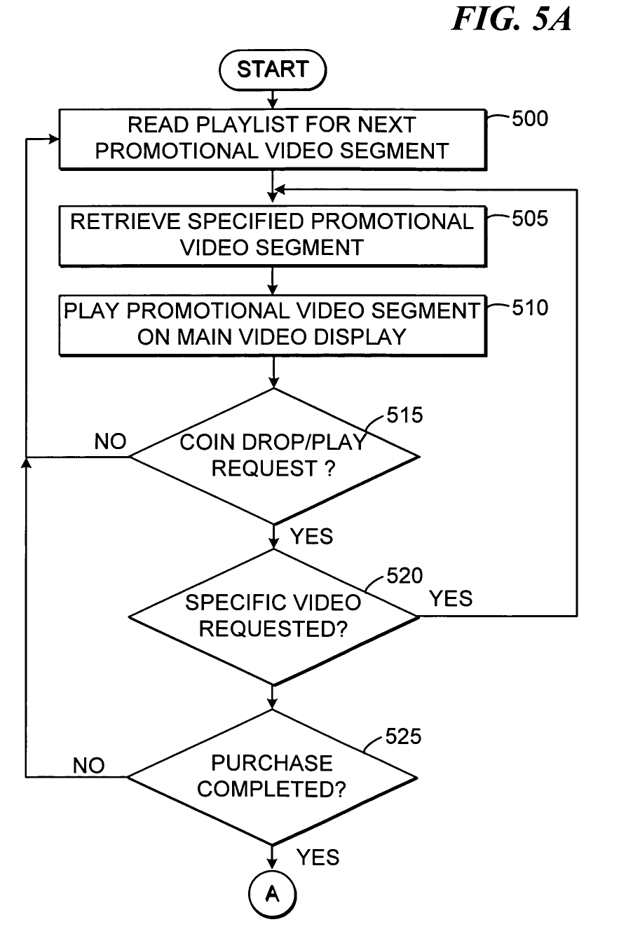

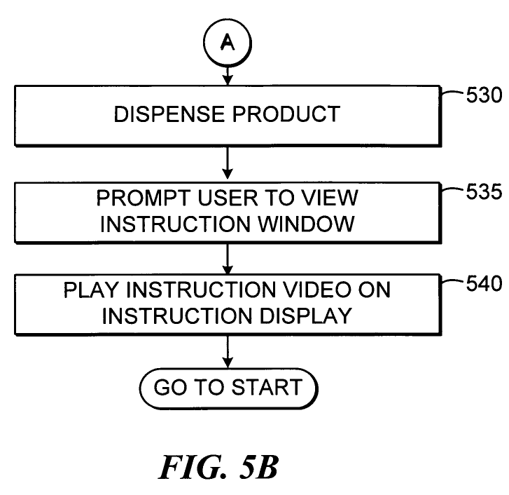

Turning to FIGS. 5A and 5B, there is presented a method of one embodiment of the present invention in form of a flow diagram, regarding operation of the previously-described video displays (35, 300, 305) and system. When the machine (10) is activated, a processor (FIG. 3, 320) reads a selected playlist (500) from storage device (FIG. 3, 310) and identifies a next promotional video segment to be presented on the publicly-viewable display (FIGS. 1 & 4, 35; FIG. 3, 300). That specified segment is retrieved (505) from the storage device (FIG. 3, 310) and played (510) on the displays (FIGS. 1, 2, & 4, 35; FIG. 3, 300) and through speakers (FIGS. 1, 2 & 4, 37). At the end of the presentation of the requested video segment, the system of the present invention continues to monitor (515) whether a coin drop condition has occurred or whether a potential customer has requested playback for a specific item from the keypad (FIGS. 1 & 4, 50). If no coin drop or request has been made, the system continues with reading the next element in the playlist (500) thereby forming a cycle of displaying continuously items specified in a playlist until a purchase or request condition occurs. If, however the system does detect a coin drop/purchase event or a play request event (520), then in the condition that a specific demonstration was requested, the demonstration indicia provided by the customer is validated and provided to step (205), whereby the video segment that is correlated to the provided indicia is retrieved and played on the display unit (FIG. 3, 300). If the customer begins a purchase condition 525, but does not complete the transaction, the system returns to the state (500) whereby the next promotional segment in a playlist is selected for presentation. Turning to FIG. 5B, if a purchase condition exists, then once the purchase is completed (525), the product is dispensed (530), the user is prompted (535) by audio, video or a combination to view the instruction display (FIG. 3, 305), and the confidential instructional video is played (540) on the instruction display (FIG. 3, 305). In one embodiment, the main display (FIGS. 1 & 4, 35) blanks except for the prompt to view the instructional display, and audio is either suppressed completely or played in a manner that is only perceivable by the customer, such as at a very low volume, internally to the machine (10), or through headphones (not shown). In an alternate embodiment, the instructional display will not occur until a user presses a button (for instance, on keypad 50), and if the keypad is not depressed after some period of time, for instance 30 seconds, the instructional video is aborted and the system returns to the playlist selection step (500). At the end of the instructional video presentation, the system returns to the playlist selection step (500) to present the next promotional video in sequence.

While preferred embodiments of this invention have been shown and described, modifications thereof can be made by one skilled in the art without departing from the spirit or teaching of this invention. The embodiments described herein are exemplary only and are not limiting. Many variations and modifications of the apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims that follow, the scope of which shall include all equivalents of the subject matter of the claims.

1. A vending machine for selling magic, pranks, and gags, comprising:
a storage area for products to be vended;
a transparent panel enclosing said storage area;
a plurality of augers and trays;
a product delivery cavity;
a publically-viewable video display;
a privately-viewable video display; and,
a selector panel.

2. The vending machine of claim 1 further comprising one or more speakers.

3. The vending machine of claim 1 further comprising a microphone.

4. The vending machine of claim 1 further comprising a speech recognition means.

5. The vending machine of claim 1 further comprising an instructional display device.

6. The vending machine of claim 1 further comprising a card reader/writer.

7. The vending machine of claim 1 further comprising a means to transmit and receive machine and transaction data.

8. The vending machine of claim 7, whereby said machine and transaction data comprises inventory information.

9. The vending machine of claim 7, whereby said machine and transaction data comprises audio/video information.

10. The vending machine of claim 7, whereby said machine and transaction data comprises machine status information.

11. The vending machine of claim 7, whereby said machine and transaction data comprises product order information.

12. The vending machine of claim 7, whereby said transmit and receive means is implemented through a wireless interface.

13. The vending machine of claim 12 whereby said wireless interface is Bluetooth.

14. The vending machine of claim 12 whereby said wireless interface is implemented in wireless standard IEEE 803.11.

15. The vending machine of claim 12 whereby said wireless interface is implemented via a cellular telephone network.

16. The vending machine of claim 12 whereby said wireless interface is implemented via a satellite link.

17. The vending machine of claim 7, whereby said transmit and receive means is implemented through a wired connection to a PSTN.

18. The vending machine of claim 17, whereby said wired connection utilizes the Internet network.

19. A method of selling magic, pranks, and gags comprising:
displaying promotional information on a display of a vending machine, said promotional information comprising a demonstration and a product indicia;
accepting and authorizing tender of payment by a customer;
accepting said customer's input indicating selection by a product indicia;
authorizing payment tendered by said customer;
operating said vending machine to dispense a product corresponding to said product indicia; and
providing instructions that teaches said customer how to perform said dispensed product, whereby said instructions are only viewable by said customer.

20. The method of claim 19 further comprising the step of producing a purchase receipt upon successful completion of a purchase transaction.

21. The method of claim 20 further comprising the step of printing an authorization code and internet address on said purchase receipt.

22. The method of claim 21 whereby access is granted for said printed authorization code for a limited number of times.

23. A method for promoting sales in a video machine comprising the steps of:
a. reading a playlist to determine a next promotional video segment;
b. retrieving said next promotional video segment from a storage device;
c. displaying promotional information on a display of said vending machine, said promotional information comprising a demonstration and a product indicia;
d. monitoring for a purchase condition or a play request provided by inputs from a potential customer, further comprising the steps of:
d1. proceeding to step a. if no purchase or play request condition was detected;
d2. if a play condition is detected, accepting an indicia from said potential customer and providing said indicia to step b. for determining said next promotional video to be played;
d3. if a purchase transaction is completed, performing the steps of:
dispensing a product correlating to said indicia;
prompting the customer to view an instructional video presentation; and,
presenting an instructional video in a private instruction display.

24. The method of claim 23 further comprising providing an audio annunciation to attract potential customers.
